(19) United States
(12) Patent Application Publication
(10) Pub. No.: US 2006/0210144 A1
(43) Pub. Date: Sep. 21, 2006

(54) Method and apparatus for reviewing defects

(76) Inventors: Kazuo Yamaguchi, Sagamihara (JP); Toshifumi Honda, Yokohama (JP); Yuji Takagi, Kamakura (JP); Munenori Fukunishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/325,552

(22) Filed: Jan. 5, 2006

(30) Foreign Application Priority Data
Mar. 15, 2005 (JP) 2005-072391

(51) Int. Cl. G06K 9/00

(52) U.S. Cl. 382/149

(57) ABSTRACT

A reviewing apparatus, for enabling to conduct detailed review (ADR) and/or defect classification (ADC), effectively, through making alignment of defects detected in an upstream inspecting apparatus into the reviewing apparatus, with certainty and at high accuracy, and further within a short time-period, comprises a defect selecting portion 240 for selecting or picking up a plural number of alignment candidates from a large numbers defects, upon defect inspection information, which is detected within the inspecting apparatus, an electron microscope 21 (30) for obtaining a SEM image of the plural number of alignment candidates, through picking up an image on each of the plural number of alignment candidates, which are selected or picked up, narrowly, and a determining portion 243 for calculating out characteristic quantities relating to the plural number of alignment candidates, upon basis of the obtained SEM images thereof, and for determining on suitableness/unsuitableness for use in alignment relating to the plural number of alignment candidates, upon basis of the characteristic quantities calculated therewith.

### BACKGROUND OF THE INVENTION

The present invention relates to a defect testing or inspecting system for testing or inspecting details of detects lying on an object to be tested, such as, a mask to be used in manufacturing semiconductor wafers and/or semiconductor devices, and in particular, it relates to a review apparatus and a review method for reviewing the detects lying on a surface of the object to be tested, so as to classify them.

High density and high integration are achieved upon the semiconductor devices, through miniaturization of designing rule of patterns (for example, width of a line). Accompanying this, it is also necessary to detect the defects, being finer than before, i.e., having size of about several ten nanometers, for example, under the present situation.

Then, conventionally, an optic type inspecting apparatus having a low resolution power in inspection, but having a high throughput, to be disposed in an upstream of manufacturing processes, is already known, wherein review (ADR) and defect classification (ADC) are conducted in the following steps: i.e., inspection is made on the entire or a part of a wafer, in advance, to confirm presence of the defects, such as, foreign matters, etc., and the position of defects detected is memorized in the form of coordinates on the wafer, and then the memorized coordinates on the wafer is inputted into a reviewing apparatus (e.g., a scanning electron microscope (SEM)) through a communication means or a memory medium, thereby executing alignment (i.e., positioning) so that the defects enters into an inside of a field of view for observation field of the reviewing apparatus, upon basis of the coordinates.

However, relating to such the inspecting apparatus, required to be high of throughput thereof, and the reviewing apparatus, required to be high in the resolution power for observation, they are prepared or built up, separately, to be the apparatuses differing from each other, in many cases. With this, a coordinate system on the defects, which are detected by the inspecting apparatus disposed in an upstream, differs from a coordinate system (i.e., a stage coordinates) of the detects, which are detected by the reviewing apparatus, and this causes an offset on the positions of defects, in particular, when executing the alignment on the reviewing apparatus.

Then, for example, Japanese Patent Laying-Open No. Hei 11-167893 (1999) describes therein a scanning electron microscope, enabling to find out such the fine or minute foreign matters within the field of view in the scanning electron microscope, even in cases where various error factors are included in the coordinate data obtained from the foreign matter inspecting apparatus, having the following steps; e.g., an error is calculated out between the position coordinate of the foreign matter, which is detected by means of the foreign matter inspecting apparatus, and the position coordinate of that, which is detected by means of the scanning electron microscope, so as to determine an equation for converting the coordinates that the said error comes down to be the minimum, while the coordinate data obtained from the foreign matter inspecting apparatus is converted with using the coordinate converting equation mentioned above, so as to make alignment on the scanning electron microscope, and thereby conducting the alignment upon the said position coordinate. Further, in the published document of prior art, it is described that automatic selection can be made on the foreign matter, the coordinate value of which can be registered into the scanning electron microscope, and/or which can be applied into derivation of the coordinate conversion equation, with use of classification data, such as, sizes and/or sorts, etc., of the foreign matters, which are determined or set up in advance fitting to the sensitivity on measurement in the foreign-matter detecting apparatus.

The similar description can be found also in U.S. Pat. No. 5,267,017, for example.

On the other hand, Japanese Patent Laying-Open No. 2002-39959 (2002), for example, describes therein a defect inspecting system for observing defects, wherein selection is made on the detects, which can be easily detected by means of a SEM observation apparatus, based on of the position coordinates and attributes of plural numbers of defects, which are detected by an optical-type inspecting apparatus, so as to detect and observe the defects within the SEM observation apparatus, by using those defects as an index, and the coordinate conversion equation is produced for expressing an interrelation between the position coordinates of those defects within both apparatuses, so as to convert the position coordinates of defects within the SEM observation apparatus.

Further, in the Japanese Patent Laying-Open No. 2002-39959 (2002) mentionedabove, it is described to the diffused or scattered light, corresponding to that, being equal or larger than 1 micrometer and equal or less than 3 micrometer in the wavelength thereof, with using the fact that there is a certain interrelationship between the laser scattered lights and sizes of the foreign matters, being the detects.

However, none of those patent documents 1 to 3 mentioned above describes that the detailed review (ADR) and the defect classification (ADC) be conducted, with high efficiency, by executing alignment on the defects detected in the inspecting apparatus into the reviewing apparatus, with certainty and at high accuracy, but within a short time period, by further picking up or screening the alignment candidates suitable for the alignment, closely or narrowly, upon basis of the SEM picture or image observed on the reviewing apparatus, from the alignment candidates selected with using the classification data, such as, the sizes and sorts of the defects, such as the foreign matters or the like, which are detected from the inspecting apparatus provided in the upstream.

### SUMMARY OF THE INVENTION

An object, according to the present invention, is to provide a reviewing apparatus and a reviewing method enabling the detailed review (ADR) and the defect classification (ADC), with high efficiency, by executing the alignment upon the defects detected within an inspecting apparatus in the upstream, for a reviewing apparatus, with certainty and at high accuracy, but within a short time period.

Namely, accordingly to the present invention, it is possible to achieve the positioning and the detailed inspection, with stability and within a short time period, with the reviewing apparatus, by finding out a plural number of defect candidates being suitable for alignment, with using attributes of defects, which can be obtained through effectively picking up or screening the defects, primarily, based on the defects size and the actual-time defect classification information, etc., obtained from the inspecting apparatus, and obtaining an image picked up on defect under an image picking-up mode from the reviewing apparatus, for easily making the detection of fine defects from a wide view field, and further analysis upon that defect image obtained, and thereafter, conducting compensation on the position coordinates with using the most suitable defects, which are selected secondarily through determination on suitableness/unsuitableness of the defect candidates to be a reference.

And, according to the present invention, there are provides a reviewing apparatus and a reviewing method thereof, for achieving a review through observation by a detecting system, which is constructed with an electron microscope or an optic microscope, by calculating out the compensation position coordinates for the defects at desire within the reviewing apparatus, which are compensated by alignment compensation coefficients upon basis of the position coordinates obtained from the inspecting apparatus about the defects at desire lying on the surface of the target to be inspected, which are inspected within the inspecting apparatus provided in an upstream, comprising: a memorizing portion for memorizing defect inspection information about a large number of defects lying on a surface of an target to be inspected, which are detected within said upstream inspecting apparatus; a defect selecting portion for selecting and picking up a plural number of alignment candidates, narrowly, from said large number of defects, upon basis of sorts and/or attribute information included within the defect inspection information memorized in said memorizing portion; a detecting system for obtaining SEM images or optic images of the plural number of alignment candidates, which are selected narrowly within said defect selecting portion, by picking up an image thereof, respectively; an image processing portion for calculating out characteristic quantities indicative of attributes about the plural number of alignment candidates, from the SEM images or the optic images of the plural number of alignment candidates, which are obtained in said detecting system; a determining portion for determining on suitableness/unsuitableness for use in alignment, about said plural number of alignment candidates, upon basis of the characteristic quantities indicative of attributes about the plural number of alignment candidates, which are calculated in said image processing portion; and a relative position compensating portion for calculating out alignment compensation coefficients from position coordinates obtainable from said inspecting apparatus, which are included within said defect inspection information, about the plural number of alignment candidates, which are determine to be suitable for use in alignment within said determining portion, and position coordinates within said reviewing apparatus, which are calculated from the SEM image or the optic image of said alignment candidates.

Also, according to the present invention, there are provides a reviewing apparatus and a reviewing method thereof, for achieving a review through observation by a detecting system, which is constructed with an electron microscope or an optic microscope, by calculating out the compensation position coordinates for the defects at desire within the reviewing apparatus, which are compensated by alignment compensation coefficients upon basis of the position coordinates obtained from the inspecting apparatus about the defects at desire lying on the surface of the target to be inspected, which are inspected within the inspecting apparatus provided in an upstream, comprising: a memorizing portion for memorizing defect inspection information about a large number of defects lying on a surface of an target to be inspected, which are detected within said upstream inspecting apparatus; a defect selecting portion for selecting and picking up a plural number of alignment candidates, narrowly, from said large number of defects, upon basis of sorts and/or attribute information included within the defect inspection information memorized in said memorizing portion; an electron microscope for obtaining SEM images of the plural number of alignment candidates, which are selected narrowly within said defect selecting portion, by picking up an image thereof, respectively; an image processing portion for calculating out characteristic quantities indicative of attributes about the plural number of alignment candidates, from the SEM images of the plural number of alignment candidates, which are obtained in said electron microscope; a determining portion for determining on suitableness/unsuitableness for use in alignment, about said plural number of alignment candidates, upon basis of the characteristic quantities indicative of attributes about the plural number of alignment candidates, which are calculated in said image processing portion; and a relative position compensating portion for calculating out alignment compensation coefficients from position coordinates obtainable from said inspecting apparatus, which are included within said defect inspection information, about the plural number of alignment candidates, which are determine to be suitable for use in alignment within said determining portion, and position coordinates within said reviewing apparatus, which are calculated from the SEM image of said alignment candidates.

Also, according to the present invention, said defect selecting portion picks up, narrowly, spherical defects of middle-class sizes, upon the sorts and/or the attribute information of said defects.

Also, according to the present invention, said defect selecting portion selects a predetermined number of the alignment candidates from each of blocks, which are divided into plural numbers thereof on the surface of said target to be inspected.

Also, according to the present invention, the attribute information of said defects within said defect selecting portion is indicative of sizes of the defects.

Also, according to the present invention, the characteristic quantities calculated out to be the attributes about the alignment candidates within said image processing portion are contrasts and/or outline configurations, and within said determining portion, the suitableness/unsuitableness for alignment are determined on the alignment candidates upon basis of said contrasts and/or outline configurations.

Also, according to the present invention, the suitableness/unsuitableness for alignment are determined by comparing the characteristic quantities indicative of the attributes of said alignment candidates with a reference value, within said determining portion.

Also, according to the present invention, the reviewing apparatus further comprising an optical microscope for obtaining an optic image of the defects or the alignment candidates.

Also, according to the present invention, an image picking up is made on the alignment candidates with a field view, which is wider than that when conducting defect observation (ADR), and at a image sampling number, which is larger than that when conducting the defect observation (ADR).

Thus, according to the present invention, it is possible to pickup or select the alignment candidates, closely or narrowly, to be suitable for use in the reviewing apparatus, through determination on suitableness/unsuitableness for the alignment candidates, upon basis of the images picked up of the alignment candidates, which are selected primarily within the reviewing apparatus, and as a result thereof, it is possible to conduct the detailed review (ADR) and the defect classification (ADC), with high efficiency, while making alignment upon the defects detected within the inspecting apparatus into the reviewing apparatus, with certainty and at high accuracy, and further within a short time period.

Those and other objects, features and advantages of the invention will apparent from the following more detailed description of preferred embodiments of the invention, as illustrated in the accompanying drawings.

### BRIEF DESCRIPTION OF THE SEVERAL VIEWS OF THE DRAWING

FIG. 1 is a view for showing outlook structures of an embodiment of the principle portions of a reviewing apparatus, in relation with an inspecting apparatus disposed in an upstream thereof;

FIG. 2 is a structure view for showing an embodiment of the reviewing apparatus, which comprises a scanning electron microscope, as a detection system thereof;

FIG. 3 is a structure view for showing an embodiment of the reviewing apparatus, which comprises a scanning electron microscope and an optic microscope, as a detection system thereof;

FIG. 4 is an outlook structure view of a first embodiment of an optical inspecting apparatus disposed in the upstream, according to the present invention;

FIG. 5 is an outlook structure view of a second embodiment of the optical inspecting apparatus disposed in the upstream, according to the present invention;

FIG. 6 is a view for showing an example of classification data of detects, which are detected by the inspecting apparatus disposed in the upstream, according to the present invention;

FIG. 7 is a view for explaining the definition of projected lengths (dx,dy), being one of sizes of spherical defects, to be applied in a primary selection, according to the present invention;

FIG. 8 is a flowchart for showing a first embodiment of executing the defect review (ADR) and the defect classification (ADC), within the reviewing apparatus according to the present invention;

FIG. 9 is a flowchart for showing a second embodiment of executing the defect review (ADR) and the defect classification (ADC), within the reviewing apparatus according to the present invention;

FIG. 10 is a view for showing an example of a display screen within the reviewing apparatus according to the present invention;

FIG. 11 is a view for showing an example of map data of alignment candidates, which are primarily selected from the defects detected in within the inspecting apparatus, through picking up or screening, narrowly, for each of small blocks upon a sample, according to the present invention;

FIG. 12 is a view for showing an example of the candidate map data to be registered into memory portion of characteristic quantities of defects, constructed with the characteristic quantity (such as, contrast and an outline configuration, for example) as attribute information, which can be obtained upon basis of a SEM picture of the alignment candidates primarily selected for each of the small blocks within the reviewing apparatus, and the position coordinates obtained upon basis of the SEM picture mentioned above and suitableness/unsuitableness for alignment determined upon basis of the characteristic quantities mentioned above, according to the present invention;

FIG. 13 is a view for showing an example of map data to be secondarily registered into the memory portion of characteristic quantities of defects, by adding the map data shown in FIG. 12 to the map data shown in FIG. 11 of the spherical defects for use of alignment, which are determined to be suitable in the reviewing apparatus, according to the present invention; and

FIG. 14 is a flowchart for showing the steps in case where re-capturing is made on the SEM picture within the first embodiment shown in FIG. 8.

### DESCRIPTION OF THE PREFERRED EMBODIMENTS

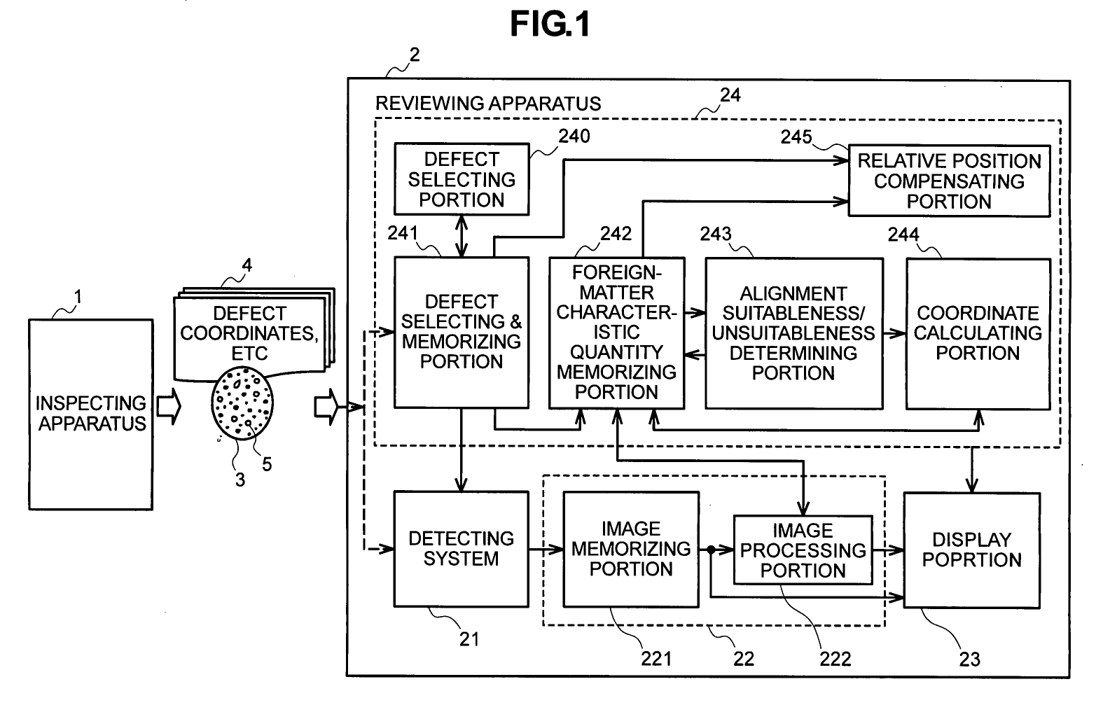

Hereinafter, explanation will be made on embodiments of the reviewing apparatus and the reviewing method, according to the present invention, by referring to the attached FIGS. 1 through 12 and 14.

FIG. 1 is the view for showing outlook structures of an embodiment of the principle portions of a reviewing apparatus, in relation with an inspecting apparatus disposed in an upstream thereof.

Before initially conducting the detailed observation within the reviewing apparatus 2 of type of an electron, etc., for example, defect inspection information 4 is inputted and memorized into a defect selecting memory portion 241, being inputted through a network (not shown in the figure) or a recording medium, etc., for example, in advance, within the reviewing apparatus 2 of type of an electron, etc. This defect information 4 includes information indicating position coordinates (x,y) of defects and attributes of defects, including therein the information of the sorts or kinds of the defects 5, such as, foreign matters, pattern defects, scratches and/or defects under films, etc., on a sample (e.g., a substrate subjected to inspection), such as, a wafer, etc., which are detected by an inspecting apparatus disposed in an upstream. Further, on a sample base (not shown in the figure) disposed on stages 31 and 32, which are included within a detecting system 21 of the reviewing apparatus 2, there is set the sample 3, such as, the wafer, etc., which was inspected within the inspecting apparatus 1 in the upstream.

The reviewing apparatus 2 comprises the detecting system 21 for obtaining a SEM picture or image taken by irradiating electron beams upon the sample 3, an image processing system 22 for processing the SEM image of the sample, which is obtained within the detecting system 21, a display portion for displaying thereon an image of the foreign matters detected and information thereof, and a generalized or general computer system 24 for conducting control upon the apparatus as a whole.

The image processing system 22 comprises: a defect selecting portion (this may be the general computer system 24), for reading out defect inspection information 4 (e.g., information indicative of the sorts, the position coordinates and/or the attributes of the defects, etc.), which is memorized in the defect selecting memory portion 241, so as to select spherical defects (e.g., a convex-like defect: foreign matters) from a viewpoint of the sorts of defects, which are relatively determined in the configuration thereof and an improvement can be expected in accuracy of position compensating factors or coefficients for use of alignment, and for dividing the sample into regions or areas in plural numbers, equally, to conduct a filtering process (i.e., picking-up or screening process) or the like upon the foreign matters having a size of middle-class for each of the areas divided, and giving orders or ranking to them, so as to select the foreign matters of primary candidates for use in alignment, thereby registering them into the defect selecting memory portion 241, primarily; an image memorizing portion 221, for reading out the spherical defects (e.g., the convex-like defect: foreign matters), which are primarily registered by means of the said defect selecting memory portion 241, so as to memorize a SEM image of foreign matters which is taken within the inspecting system 21; and an image processing portion 222, for extracting an image of a desired foreign matter from the SEM image of foreign matters, which are primarily registered and memorized in the said image memorizing portion 221, so as to processing the said image of the desired foreign matter extracted, and thereby, extracting information of characteristic quantities of the foreign matters, such as, contrast indicative of an attribute of the foreign matters, an outline configuration, etc., to be registered into a memory portion 242 of characteristic quantities of defects, secondarily.

The display portion 23 displays thereon images and/or information of the primarily registered spherical defects (e.g., the foreign matters), which are memorized in the image memorizing portion 221, and/or images and/or information of the secondarily registered foreign matters, which are memorized in the image memorizing portion 221, which are obtained from the image processing portion 222.

The general computer system 24 comprises: the defect selecting memory portion 241, for memorizing therein the defect inspection information 4 (e.g., information of the sizes, indicative of the sorts, the position coordinates and/or the attributes of the defects, etc.), which can be obtained from the inspecting apparatus 1 in the upstream, and the primary candidates of foreign matters for use of alignment, which are selected; the defect characteristic quantity memorizing portion 242, for memorizing therein the characteristic quantities, such as, the contrast and the outline configuration, etc., indicative of the attribute of foreign matters, images of which are picked up in the detecting system 2 and are extracted in the image processing portion 222 upon basis of position coordinates of the primary candidates of foreign matters memorized in the said defect selecting memory portion 241, together with defect No. of the primary registration, thereby achieving the secondary registration; a determining portion 243, for determining suitableness/unsuitableness of the foreign matters for use in alignment, upon basis of the characteristic quantities indicative of the attributes of foreign matters, which are memorized in the said defect characteristic quantity memorizing portion 242; a coordinate calculating portion 244 for calculating out the position coordinates (X+ΔX,Y+ΔY) about the plural numbers of foreign matters determined to be suitable in the said determining portion 243, within the coordinate system on the sample; and a relative position compensating portion 245, for calculating out alignment compensation factors or coefficients (e.g., relative position compensation factors or coefficients) (such as, α₁₁, α₁₂, α₂₁, α₂₂, X₀, and Y₀) for use in alignment, upon basis of the position coordinates (X,Y) of the plural numbers of foreign matters, which are determined to be suitable for alignment and can be obtained from the inspecting apparatus 1, and calculation results of the position coordinates (X+ΔX,Y+ΔY) about the plural numbers of foreign matters, which are calculated out in the coordinate calculating portion 244, and thereby calculating out the position coordinates (x′,y′), upon which alignment should be done in relation to the detects to be reviewed in the reviewing apparatus 2, by compensating or correcting the position coordinates (X,Y) of the defects to be reviewed, which can be obtained from the inspecting apparatus 1, based on the said alignment compensation factor or coefficient calculated out, and it further performs controls upon those calculations and the entire of the apparatus, and so on.

In the reviewing apparatus 2, alignment is executed for the defects to be reviewed, upon basis of the position coordinates (x′,y′), which are calculated out within the coordinate position compensating portion 245 and corrected in relation to the defects to be reviewed, and thereby achieving the defect review (ADR: Automatic Defect Review), and also the defect classification (ADC: Automatic Defect Classification), upon basis of a result thereof.

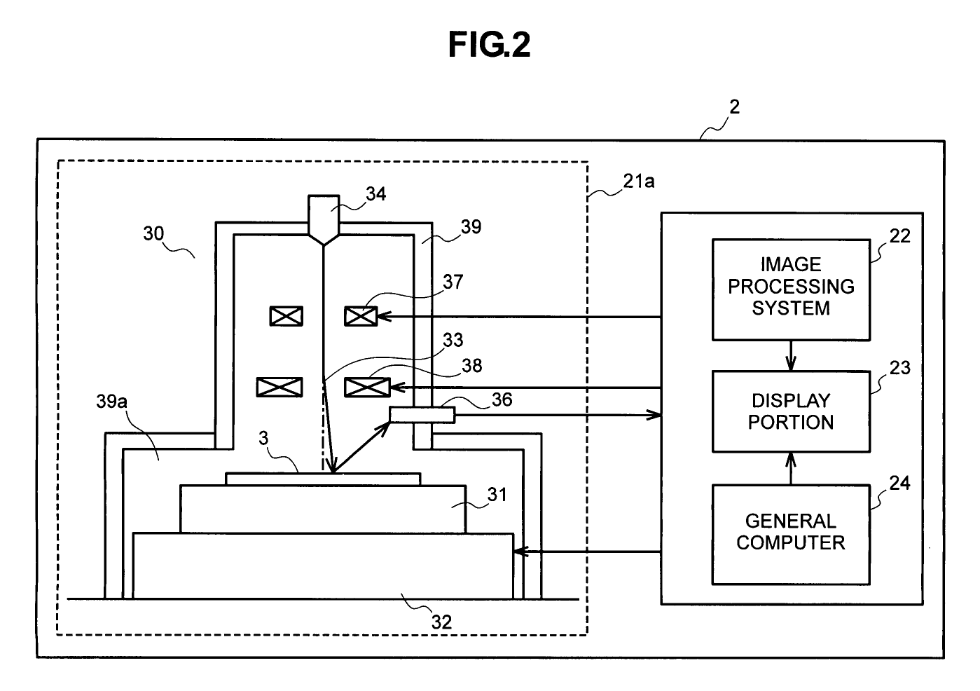

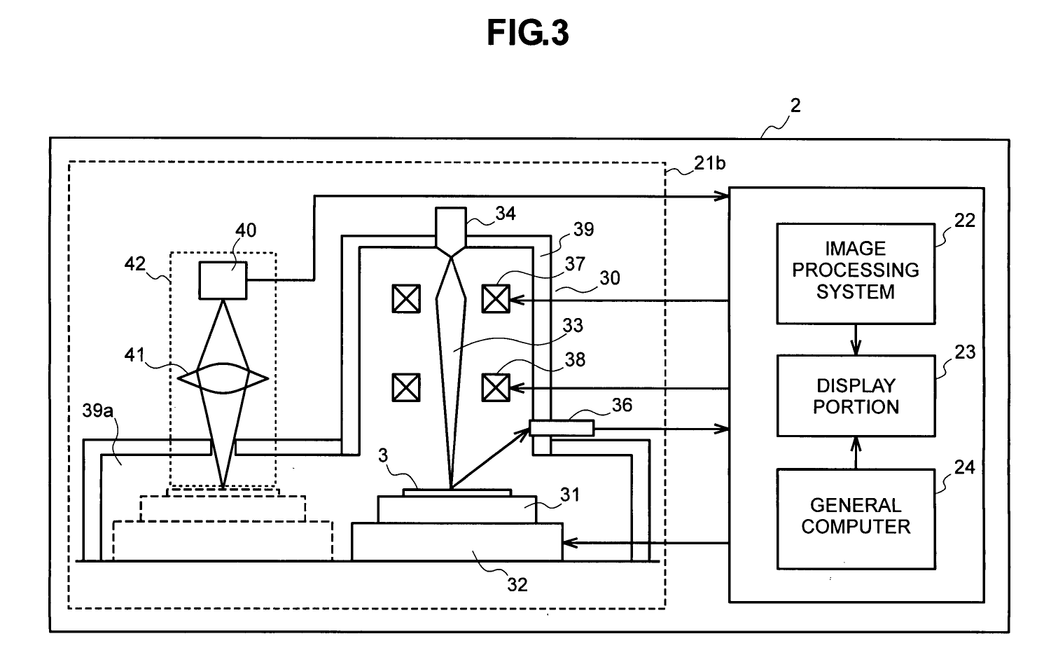

As an example of the detecting system 21 of the reviewing apparatus 2, it may be constructed with a detecting system 21a, in the structures thereof; i.e., comprising an electron microscope (i.e., SEM) 30, for picking up an image through detecting electrons, such as, secondary electrons and/or reflected electrons, by means of an electron detector 36, while scanning electron beam 33, as shown in FIG. 2, or also as is shown in FIG. 3, it is constructed with a detecting system 21b, enabling multiple inspections; i.e., an inspection by means of an optical-type optic microscope 42 (e.g., a bright-field inspecting apparatus or a dark-field inspecting apparatus, or an inspecting apparatus (not shown in the figure) having both of those), and an inspection by means of an electron microscope 30, by moving the XY stages 31 and 32 (see broken lines in the figure), on which the sample 3, such as, the wafer, etc., is mounted within a sample chamber 39a of the reviewing apparatus.

Further, an electron microscope 30 of the detecting system 21a and 21b comprises, in the structure thereof, an electron gun 34 for emitting electron beams into a vacuum chamber 39, an electron lens 37 for focusing or converging the electron beams emitted from the electron gun 34, a deflector 38 for deflecting the said electron beams 33, and an electron detector 36 for detecting the electrons, such as, the secondary electrons and/or the reflected electrons, etc. Accordingly, the electron beam 33 emitted from the electron gun 34 is focused or converged by means of the electron lens 37, and is deflected in the scanning direction thereof, in two-dimensional manner, by means of the deflector 38, to be irradiated upon the sample 3 within the sample chamber 39a. Upon irradiation of the electron beam on the sample 3 are generated the electrons, such as, the secondary electrons and/or the reflected electrons, etc., depending on the configuration and/or material of the sample, and the said electrons generated are detected by means of the electron detector 36, to be amplified and converted into digital image signals through an analog/digital converter (not shown in the figure), and are memorized into the image memorizing portion 221. At this instance, addresses within the image memorizing portion 221 are synchronized with the scanning signals of the electron beams, upon basis of the coordinate system of the XY stages 31 and 32. Also, the XY stages 31 and 32, which mounts the sample 3 thereon, can change the position, upon which the electron beams make scanning, with respect to the sample 3, by moving horizontally, declining, or rotating the sample 3, in the three-dimensional manner on the stage coordinate system, using control signals supplied from a stage control portion (not shown in the figure).

Further, the XY stages 31 and 32 comprise a measuring apparatus (not shown in the figure), such as, a laser measuring apparatus, etc., for measuring the positions of the XY stages 31 and 32 at high accuracy, so as to provide a result of measurement by said measuring apparatus to the general computer 24, and therefore, the general computer 24 achieves the positioning of the XY stages 31 and 32 at high accuracy, through controlling the XY stages 31 and 32 via a stage controller (not shown in the figure).

However, with respect to the detecting systems 21a and 21b shown in FIGS. 2 and 3, the sample can be positioned, roughly, in particular, when the sample 3, such as, the wafer, etc., is mounted on the XY stages 31 and 32, by the following manners: i.e, the outer configuration (such as, an orientation flat or a notch, etc.) of the sample 3 is detected through a detector (not shown in the figure), to calculate out an amount of shifting (e.g., the position) in the XY positions and rotating direction of the sample, upon basis of the detected outer configuration of the sample, and the said amount of shifting calculated out, at least about the position in the rotation direction, is transmitted to the general computer 24, wherein the general computer 24 executes the positioning of the orientation flat or the notch, etc, rotating the sample, roughly, with rotating the rotation stage (not shown in the figure), for example, by an amount of that rotation shifting. Of course, if the XY positions of the sample are fed back to the XY stages 31 and 32, it is possible to compensate or correct the rough XY positions (e.g., rough XT coordinates) of the sample.

Also, the optic microscope 42 shown in FIG. 3, which is provided in the detecting system 21b, is installed in the vicinity of the electron microscope within the sample chamber 39a, but separated at a position from each other, in such degree that they do not exert mutual influence upon each other. And, the stages 31 and 32 are so constructed that they can move, reciprocally, at a distance already known, between the electron microscope 30 and the optic microscope 42. The optic microscope 42 comprises a bright field light irradiating system or a dark field light irradiating system (not shown in the figure), and an optical lens 41 and a CCD camera 40, in the structures thereof.

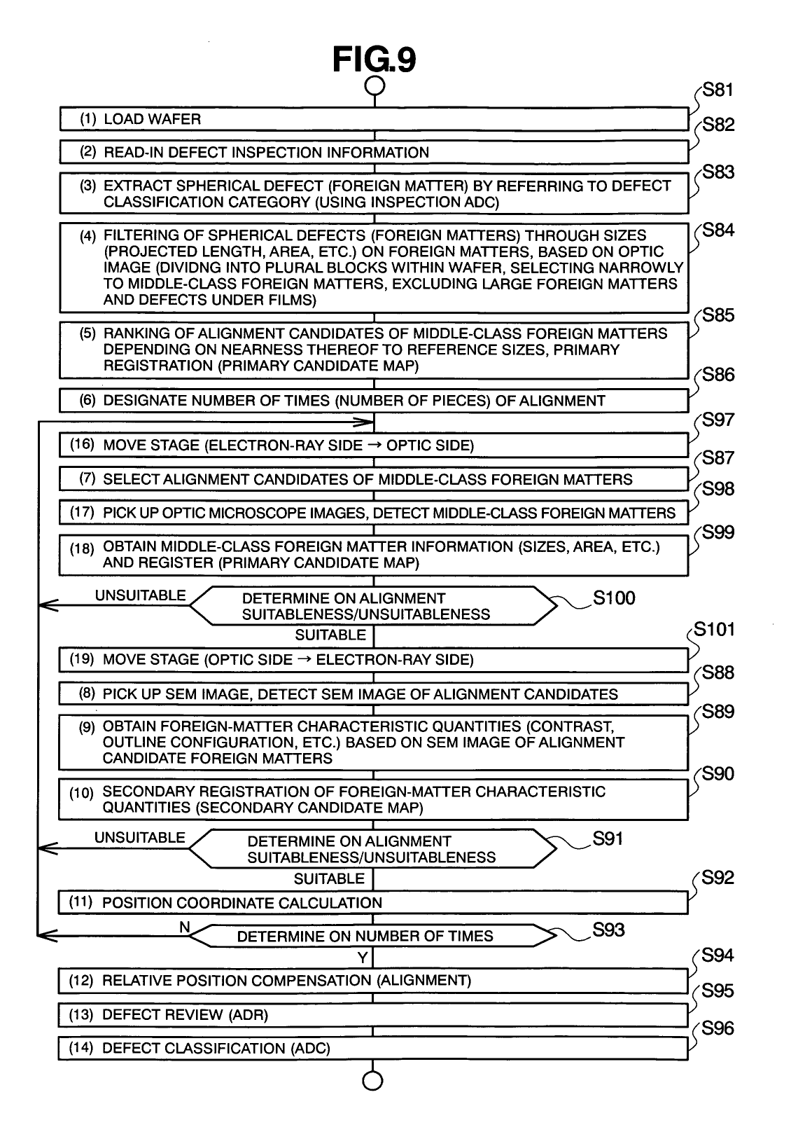

Said the optic microscope 42 is used in case when it is used for determining the suitableness/unsuitableness for alignment in advance, by confirming the information of sizes indicative of the attribute of defects (such as, (projected lengths dx,dy) and an area S), as the defect inspection information 4 obtainable from the inspecting apparatus 1 (see steps S98 to S100 shown in FIG. 9), or in case when it is impossible to obtain the (projected lengths dx,dy) and an area S, as the information of sizes indicative of the defects, in the form of the defect inspection information 4 from the inspecting apparatus 1. Thus, the optic microscope 42 is provided for the purpose of picking up an optic image of the alignment candidates of the spherical defects (i.e., the foreign matters) (obtained through the step 83 in FIG. 9) through the CCD camera, which are extracted by referring to the primarily registered alignment candidates of middle-class foreign matters (obtained through the steps S83 to S86 in FIG. 9) on the sample 3 mounted on the XY stages 31 and 32, or the classification categories of defects, and thereby obtaining the information of sizes, including the (projected lengths dx,dy) and the area S, being indicative of the attributes of defects, from the said optic image of the defects of alignment candidates picked up, within the reviewing apparatus 2.

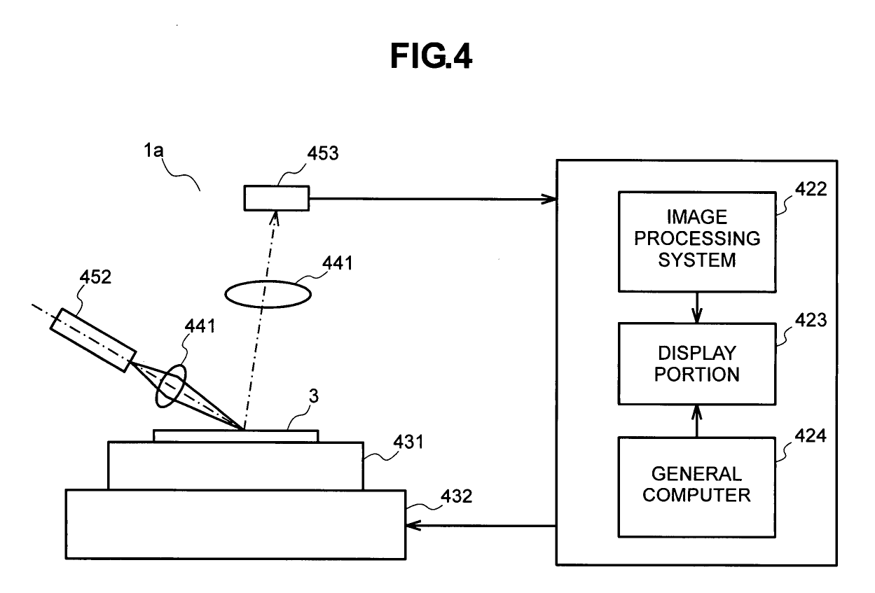

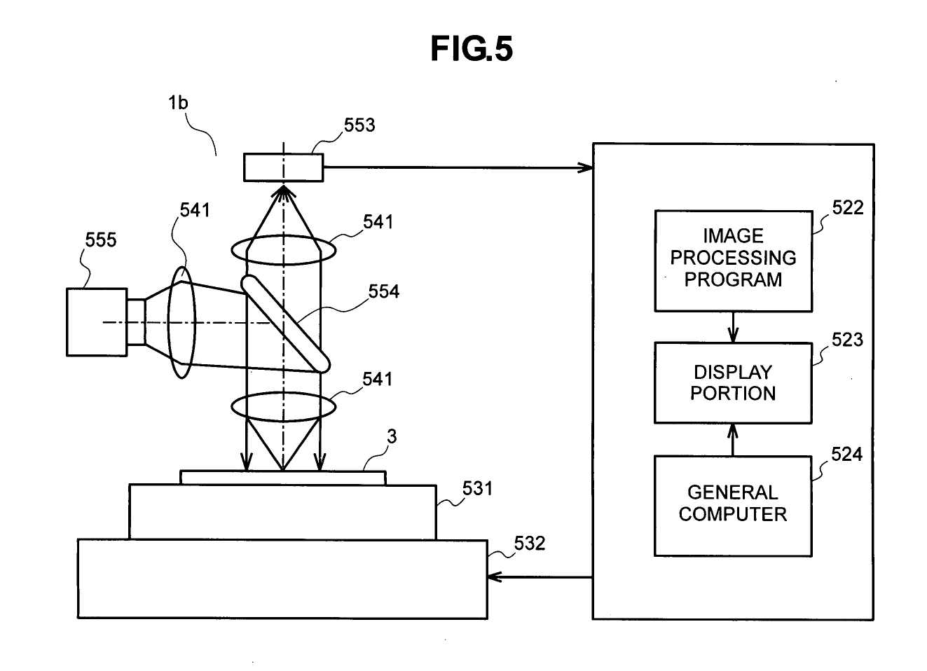

Also, as the inspecting apparatus 1 in the upstream can be applied the optic dark-field inspecting apparatus 1a shown in FIG. 4, or the optic bright-field inspecting apparatus 1b shown in FIG. 5, or further an inspecting apparatus (not shown in the figures) having both detecting systems of the dark field and the bright field, etc.

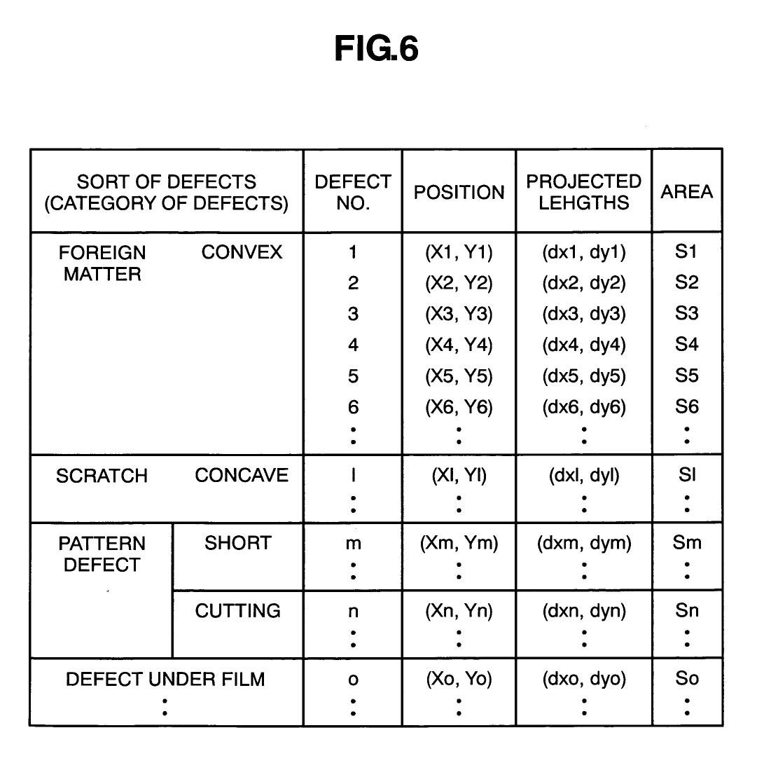

The optic dark-field inspecting apparatus 1a comprises, as is shown in FIG. 4, in the structures thereof: a laser irradiating optic system having XY stages 431 and 432 for mounting the sample 3 thereon, and a laser-light source 452 and a condensing optic system 441, thereby irradiating a condensed laser beam upon the sample 3, obliquely; a detecting optic system having an objective lens for condensing the scattered lights from the sample 3 and an image-formation lens 441 and a CCD detector 453; an image processing system 422; a display portion 423; and a general computer 424, wherein the defects, such as, the foreign matters, etc., are detected, to be converted from the defect position coordinates on the stage coordinate system relating to the defects detected, into the defect position coordinates (X,Y) on the coordinate system on the sample, upon basis of a reference position (for example, the orientation flat or the like) of the sample, such as, the wafer, etc., and thereby calculating out the defect inspection information 4, including at least the sorts of defects, a number of defects (No.), the position coordinates (X,Y) of defects, and the sizes (i.e., the projected lengths (dx,dy) and the area S) indicative of the attributes of defects, etc., as is shown in FIG. 6, to be outputted therefrom.

The optic bright-field inspecting apparatus lb comprises, as is shown in FIG. 5, in the structures thereof: an irradiating optic system having XY stages 531 an 532, a light source 555, a light-condensing optic system 541 and a half mirror 554, thereby irradiating or applying the bright-field upon the sample 3; a detecting optic system having an objective lens 541 for condensing the reflected light from the sample 3, an image-forming lens 542 and a CCD detector 553; an image processing system 522; a display portion 523, and a general computer 524, wherein the defects are detected, suchas, pattern defects, scratches, and/or defects under films, etc., for example, to be converted from the defect position coordinates on the stage coordinates relating to the defects detected, into the defect position coordinates (X,Y) on the coordinates on the sample, upon basis of the reference position (for example, the orientation flat or the like) of the sample, such as, the wafer, etc., and thereby calculating out the defect inspection information 4, including at least the sorts of defects, the number of defects (No.), the position coordinates (X,Y) of defects, and the sizes (i.e., the projected lengths (dx,dy) and the area S) indicative of the attributes of defects, etc., to be outputted therefrom.

Also, depending upon the type or kind of the inspecting apparatus 1, there are sometimes cases where the information of the sizes (i.e., the projected lengths (dx,dy) and the area S), indicative of the attributes of defects, cannot be obtained, as the defect inspection information 4.

As was mentioned above, since the stage coordinate system of the inspecting apparatus (1a, 1b) and the stage coordinate system of the reviewing apparatus 2 are the coordinate systems, which are inherent or unique to those apparatuses, respectively, then they differ from each other, even if they are converted into the coordinate system on the sample upon basis of the reference position (for example, the orientation flat or the notch, etc.) of the sample, such as, the wafer, etc. Accordingly, the position coordinates of the defects differ, finely or delicately, even upon the coordinate system on the sample.

Also, since the optic microscopes 42, which are provided within the inspecting apparatus in the upstream shown in FIGS. 4 and 5 and also within the detecting system 21b of the reviewing apparatus 2 shown in FIG. 3, both are optical in the type, therefore, the optic image obtained by detecting the defects is inferior in the sensitivity and the resolution power, comparing to an electron image, which can be obtained at a low magnification, such as, from 10,000 to 20,000 times, for example, through an electron microscope 30. For this reason, even if trying to calculate out the characteristic quantities of sizes, indicative of the attributes of defects, from the optic image of the defects, but only the sizes are calculated at a low accuracy; therefore, it is difficult to expect to obtain such high accuracy, which can be obtained with the electron microscope.

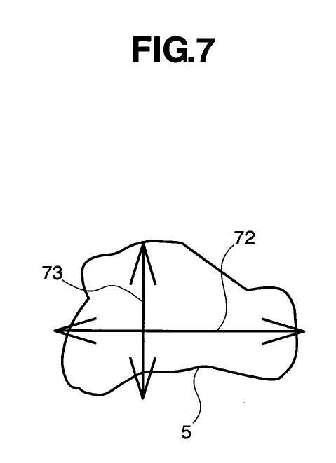

Next, explanation will be made on an operation of alignment within the reviewing apparatus 2, according to the present invention. As the defect inspection information 4 outputted from the inspecting apparatus 1, other than, at least, the defect position coordinates (X,Y) upon the coordinate system on the sample and the number of defects (No.) shown in FIG. 6, which are calculated out upon basis of the optic image, there is further included information of, such as, sorts of defects (i.e., categories of defects), for example, and they are inputted into the defect selecting memory portion 241 of the reviewing apparatus 2 through an electronic memory medium or a network between the apparatuses or of an outside thereof, to be memorized therein. Also, depending on the type or kind of the inspecting apparatus 1, there is further calculated out attribute information of defects upon basis of the optic image, such as, the projected lengths (dx,dy) indicative of the sizes of defects and/or the area S, etc., for example, as the defect inspection information 4, and they are also inputted into the defect selecting memory portion 241 of the reviewing apparatus 2 through the electronic memory medium or the network between the apparatuses or of an outside thereof, to be memorized therein. The projected lengths (dx,dy) of defects are defined by the maximum sizes of the defect 5 in the directions of X and Y, as is shown in FIG. 7, for example. For the defect inspection information 4, it is not always necessary to be memorized into the defect primarily-selecting memory portion 241, in this manner, or it may be memorized in other memory portions (not shown in the figures).

[Embodiment 1]

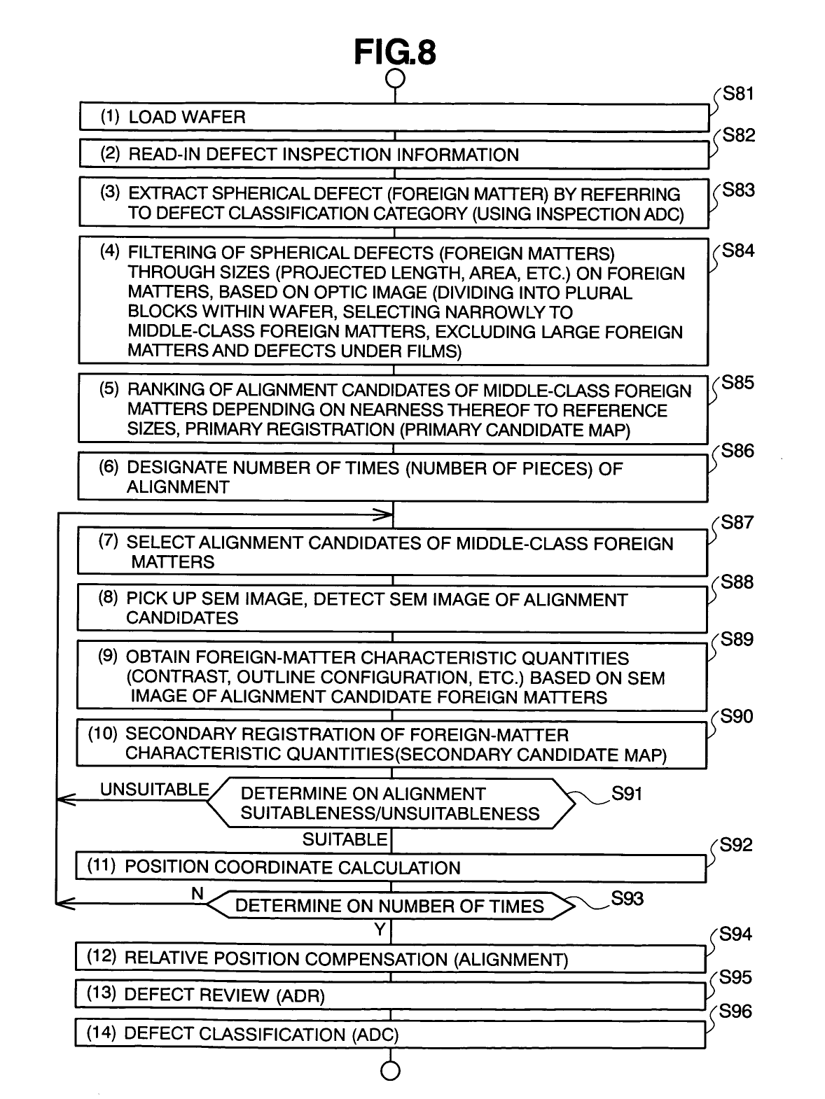

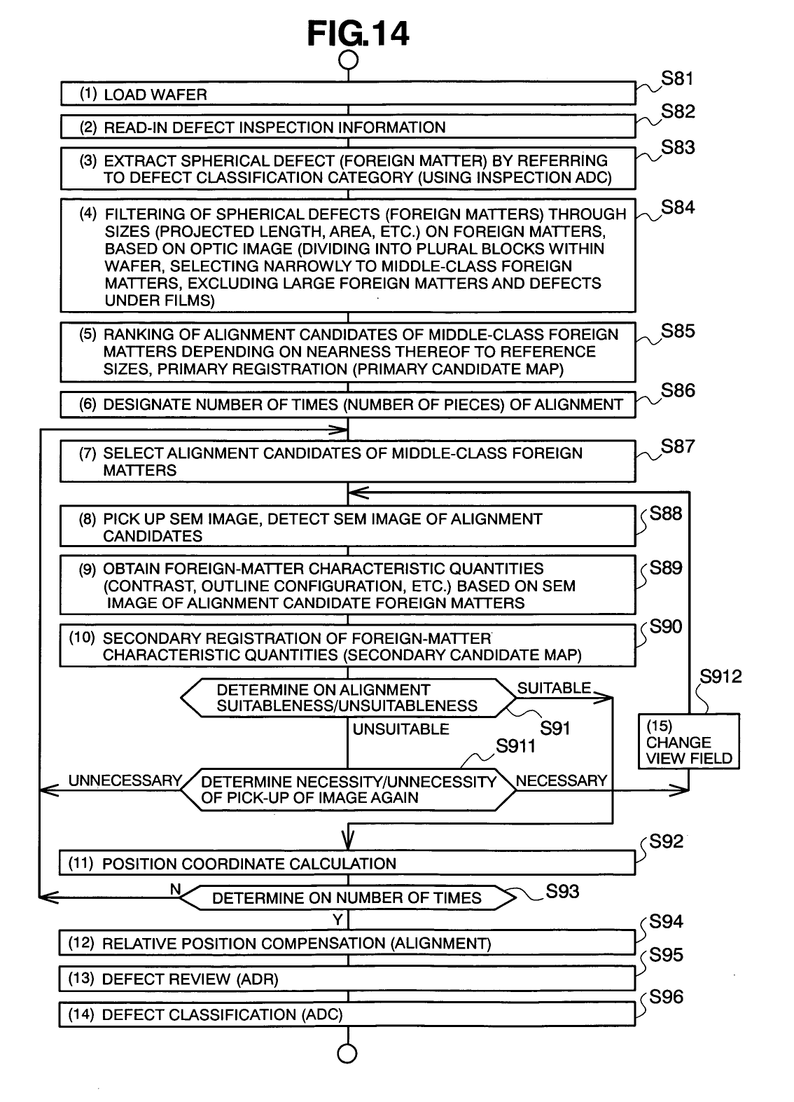

Next, explanation will be made about a first embodiment within the reviewing apparatus 2, by referring to flowcharts shown in FIGS. 8 and 14; e.g., calculating out the alignment compensation factors or coefficients (e.g., relative position compensation factors or coefficients) (such as, all, α₁₁, α₁₂, α₂₁, α₂₂, X₀, and Y₀), for use of alignment within the reviewing apparatus 2, with using the defect inspection information 4 stored within the defect selecting memory portion 241, so as to compensate or correct the position coordinates of defects, which are detected in the inspecting apparatus 1, upon basis of the alignment compensation coefficients calculated out in the above, and thereby executing the defect review (ADR) and the defect classification (ADC) within the reviewing apparatus 2, with using the said position coordinates of defects compensated. In case of the first embodiment, other than the defect position coordinates (X,Y) within the coordinate system on the sample and the number of defects (No.) shown in FIG. 6, which are calculated out upon basis of the optic image, as the defect inspection information 4 from the ordinal inspecting apparatus 1, the attribute information of detects is outputted, such as, the sorts of detects, the projected lengths (dx,dy) and/or the areas S indicative of the sizes of defects, for example, to be inputted and memorized into the defect selecting memory portion 241 of the reviewing apparatus 2.

In the reviewing apparatus 2, (1) the sample, such as, the wafer, etc., is transferred onto a mounting base within the detecting system 21 of the reviewing apparatus 2, to be set and loaded thereon (S81).

(2) Further, the defect selecting memory portion 241 reads the above-mentioned defect inspection information 4 obtainable from the inspecting apparatus, therein (S82).

(3) In this instance, since such various kinds of defects are included, as is shown in FIG. 6, in the defect inspection information 4, obtained through inspection made by the ordinary inspecting apparatus 1, a defect selecting portion 240, firstly excluding the defects under films by referring to the kinds or sorts of the said defects, conducts a filtering process (i.e., filtering), for the purpose of picking up or screening the foreign matters, being the spherical defect (e.g., the convex-like defect), each having a relatively definite or certain shape. As such the sorts or kinds of the defects mentioned above may be applied the defect classification categories of the information of real-time defect classification (i.e., an inspection ADC), which is executed in the inspecting apparatus 1. In the real-time defect classification, classification is made on the defect categories; such as, the foreign matter on a film, the foreign matter under the film, etc. It is difficult to pick up an image of the defect under the film, in many cases, because the electron beams cannot reach thereto by means of the electron microscope (SEM) 30 of the reviewing apparatus 2, and therefore it must be excluded from the defects for use of alignment, to be unqualified to it. Also, the scratching defects and/or the pattern defects, being relatively indefinite or uncertain in the configuration thereof, bring the alignment to be low in accuracy thereof; therefore, selection is made on the foreign matters, the spherical defect (e.g., the convex-like defect), being relatively definite or certain in the configuration thereof and thereby bringing about high accuracy in alignment.

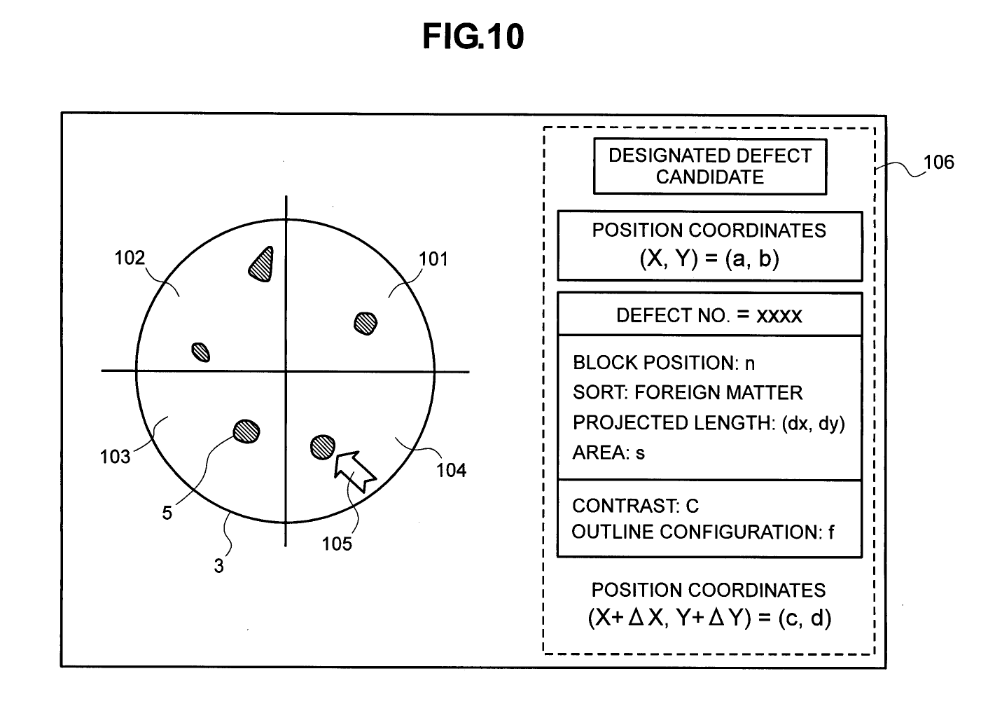

(4) Next, the defect selecting portion 240 divides the surface of the sample 3 into plural pieces of areas (blocks), as is shown in FIG. 10, for picking up the foreign matters for use of alignment, uniformly, from the entire surface of the sample 3, and then it executes filtering (e.g., filtering), upon basis of the sizes (e.g., the projected lengths (dx, dy) or the area S) of the foreign matters based on the optic image obtained from the defect inspection information 4, in particular, for excluding large foreign matters therefrom; i.e., picking up a predetermined numbers of the defects of middle-class, the sizes of which are near to the standard sizes (e.g., standard projected lengths dxs, dys, and standard areas Ss) for each of those blocks mentioned above, and thereby obtaining data of the alignment candidates, with the middle-class foreign matters, for the each block (S84). As a criterion of the size of middle-class foreign matter, selection is made on it having the size from 0.5 to 2.0 micrometer, for example. The reason, in particular, of excluding the large foreign matters, lies in that they are forced out from the view field of the electron microscope 30, in many cases, even if positioning them at a low magnification power from 10,000 to 20,000 times, upon basis of the position coordinates obtained form the inspecting apparatus 1. Also, in case of small foreign matters, it is impossible to obtain a SEM image suitable for use of alignment, having a certain degree of sizes.

Further, the configuration data of the sample within the coordinate system on the sample is also necessary, in particular, when dividing the surface of the sample 3 into the plural numbers of areas (blocks), in the above.

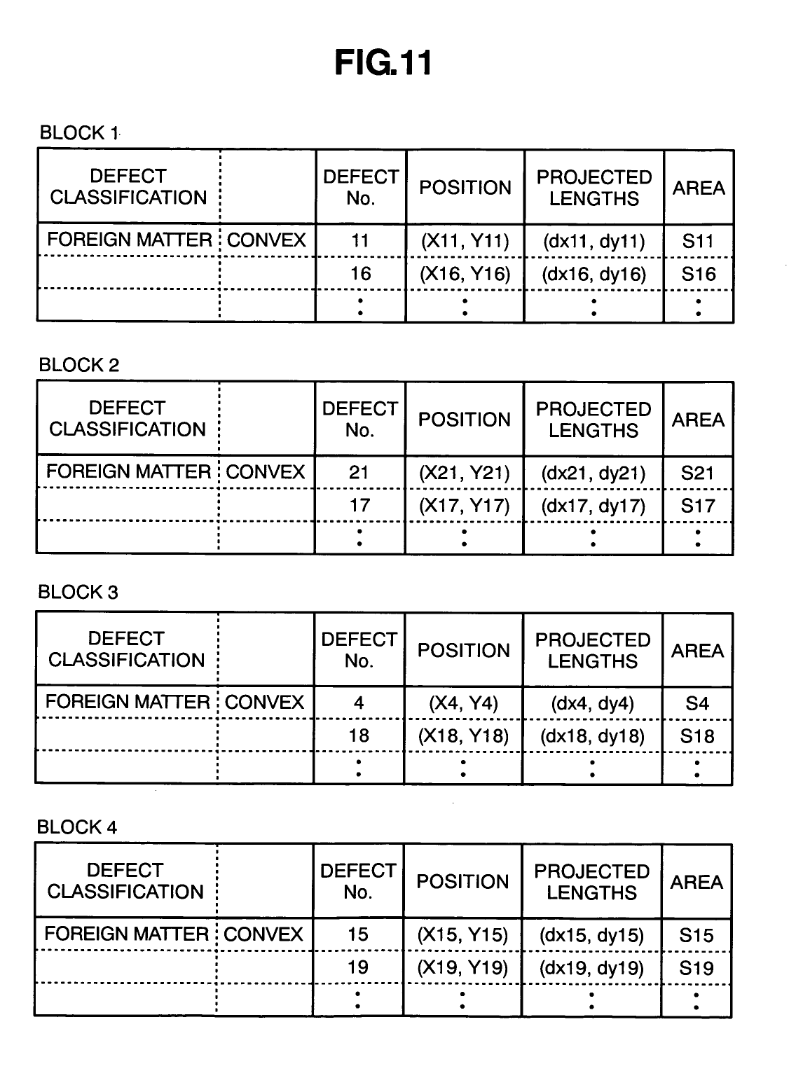

(5) The defect selecting portion 240 further decides or rearranges a ranking or order of the foreign matters (i.e., representative foreign matters), from one being near to spherical in the configuration thereof and near to the standard size in the sizes thereof, for each of the blocks, as primary candidates for use of alignment, and they are registered into a memory area within the defect selecting memory portion 241, primarily, in the form of a primary candidate map in which the order is determined for each the block, as is shown in FIG. 11 (S85).

The picking-up or screening in (3) and (4) mentioned above may be made upon basis of either the projected lengths (dx,dy) or the area S of the foreign matter, or alternately upon basis of both the projected lengths and the area. For example, as is shown in FIG. 10, the area or region of the sample 3, which is displayed on a screen of the display portion 23 in the reviewing apparatus 2, is divided into plural pieces in the areas thereof, suchas, blocks (101, 102, 103, and 104) of four (4) divided regions, for example, and then the picking-up or screening is made on the middle-size foreign matters near to the standard size, upon basis of the projected lengths (dx,dy) or the areas S of the respective foreign matters within each of the blocks. Among of the said middle-sized foreign matters picked up or screened, the order in priority is determined from that having the sizes (e.g., the projected lengths (dx,dy) or the areas S) near to the standard size, so as to make rearrangement for the representative foreign matters of primary candidates, and with such primary candidate data as shown in FIG. 11, the primary registration is conducted. This is effective, such as, in case when locally conducting compensation on the relative position for the alignment which will be mentioned later, or for maintaining or achieving the accuracy when making alignment on the sample as a whole. Or, alternately, the rearranging may be made upon the primary candidates, which are primarily selected and memorized into the memory area within the defect selecting memory portion 241, continuously, but without dividing the sample, to be the representative foreign matters thereof. This process can be made, easily, comparing and/or determining through calculation within the defect-selecting portion 240 in the general computer system 24. Also, this may be executed by a software system installed within a processing computer (not shown in the figures) to be used within the image processing system 22.

(6) Next, a number of times (i.e., a number of pieces) is designated on the screen of the display portion 23, for example, so that calculation be conducted on the position coordinates for use of alignment, for each of the blocks or the sample as a whole (S86).

(7) Next, the general computer 24 makes selection, sequentially, from the primary candidates for alignment of the middle-size foreign matters, which are primarily registered into the defect selecting portion 241, by the designated number of times (i.e., the pieces) mentioned above, and reads out the position coordinates (X,Y) of the primary candidates for alignment, so as to convert that position coordinates into the coordinate system of the XY stages 31 and 32; i.e., being supplied to a stage controller (not shown in the figures), the electron microscope 30 of the detecting system 21 (S87).

(8) As a result thereof, the primary candidates of foreign matters for use of alignment are positioned, one by one, within a field of view of the electron microscope 30 having low magnification power, such as, from 10,000 to 20,000 times. An image on those candidates for alignment of such the middle-class foreign matters, which are positioned sequentially, within the field of view of the electron microscope, in this manner, is picked up by means of the electron microscope 30, and from the electron image (i.e., the SEM image) picked up are detected the electron image of the foreign matters (i.e., foreign-matter electron image), indicating the alignment candidates among the foreign matters, to be memorized into the image memorizing portion 221 (S88). In primarily selecting the alignment candidates of the middle-class foreign matters, since it is determined to select such the foreign matters; i.e., the middle-class foreign matters having sizes from 0.5 to 2.0 micrometer, approximately, as was mentioned above, for example, which can be easily found out by means of the electron microscope 30 of the reviewing apparatus 2; therefore, even when picking up an image of the alignment candidates of the middle-class foreign matters within the electron microscope 30 at the low magnification power, such as, from 10,000 to 20,000 times, ordinarily, they can be detected in the form of an electron image having high resolution power, but without any chance that they come off, out of the field of view of the electron microscope. In this instance, the electron microscope 30 picks up the image, with a wide field of view and at high density, such as, from 4 times to 16 times (e.g., from 1,024×1,024 pixels to 2,048×2,048 pixels), approximately, comparing to that of about 512×512 pixels when reviewing in the detail observation.

Namely, with the electron microscope 30, such the image of the alignment candidates can be picked up, with a wide field of view and at high density; i.e., by picking up an image of the area or region, widely, at least beyond the view field when conducting the defect observation (ADR) of detecting the details of defects at a desire, in the view field for picking up an image of the alignment candidates, and at the sampling number of image larger than that when conducting the ADR. The reason of picking up an image with wide view field and high density, in this manner, lies to prevent the sensitivity from being lowered, in detection of the foreign matters when the pixel size comes to be large too much.

Further, even if the defects under film are selected, primarily, to be the alignment candidates, i.e., the middle-class spherical defects, in the step S85, but an image of the said defects under film, which are primarily selected, cannot be picked up by means of the electron microscope 30; therefore, they are deleted from the alignment candidates, automatically.

Next, the image processing portion 222, reading out the electron image of foreign matters (i.e., the SEM image) having high resolution power, which are detected in the step S88, from the image memorizing portion 221, executes a comparison process upon the said electron image of foreign matters, which is read out; i.e., comparing to a reference electron image having no foreign matter thereon, in the similar manner to that of repetitive cell comparison and/or dye comparison, so as to extract the middle-class foreign matters, and it memorizes that electron images into the defect characteristic quantity memorizing portion 242 (S88).

(9) The image processing portion 222 obtains a value of brightness (i.e., contrast “C”), the characteristic quantity indicative of the attribute of the middle-class foreign matter, or a value “f” of outline configuration thereof, or both values of the contrast “C” and the outline configuration value “f”, upon basis of the electron images of the middle-class foreign matters, which are extracted and memorized into the defect characteristic quantity memorizing portion 242 (S89).

(10) The characteristic quantities obtained, indicative of the attributes of the middle-class defects, are registered into the defect characteristic quantity memorizing portion 242, in the form of a map of secondary candidates (S90).

The contrast (i.e., a shade value) “C” of the middle-class foreign matters can be obtained through calculation within the image processing portion 222, by using a ratio of an averaged value (i.e., an averaged value of the shade values) of brightness of the middle-class foreign matters to an averaged value (i.e., an averaged value of the shade values) of brightness of a background, or by using a ratio of the averaged value of brightness of the middle-class foreign matters to an averaged value of brightness of the background (nearly equal to zero (0)) on an image of difference between the electron image of the foreign matter and the reference. electron image (i.e., the shade image of only the middle-class foreign matter, but almost removing the background thereof), and the outline configuration value “f” can be obtained within the image processing portion 222, by calculating a value of the ratio of two squares of a periphery length of the middle-class foreign matter to the area S of the middle-class foreign matter, which is calculated out upon the basis of the electron image of foreign matter within the image processing portion 222. Those characteristic quantities obtained are registered, secondarily, into the defect characteristic quantity memorizing portion 242, in the form of a secondary candidate map.

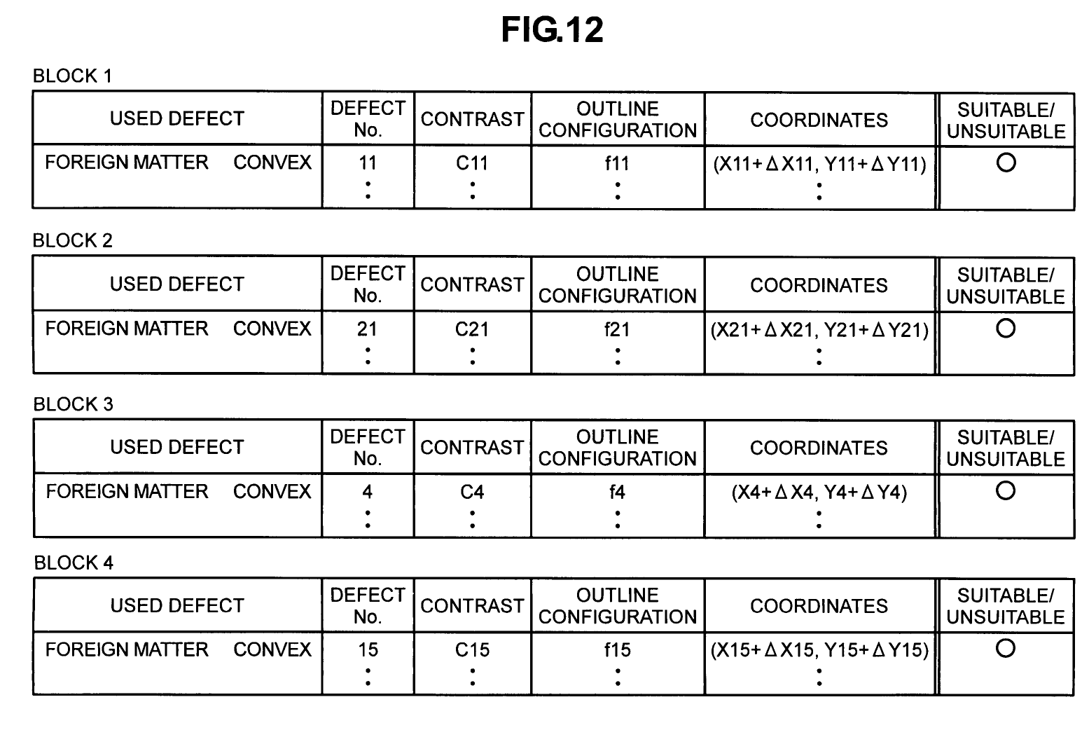

In this manner, through the secondary registration of the characteristic quantities (i.e., the contract C and the outline configuration value “f” indicative of the attributes of the middle-class foreign matters, obtained upon basis of the electron image of foreign matters, which is picked up by the detecting system 21 of the reviewing apparatus 2, into the defect characteristic quantity memorizing portion 242, together with original numbers (No.) of foreign matters, data of the candidate map data of middle-class foreign matters are produced in the defect characteristic quantity memorizing portion 242, as is shown in FIG. 12, for determining on the suitableness/unsuitableness to be used in alignment, corresponding to the areas or regions (101, 102, 103, and 104) within blocks of the wafer.

Further, the defect characteristic quantity memorizing portion 242, into which the secondary registration is made, and the defect primary selecting and memorizing portion 241, into which the primary registration is made, can be constructed with a memory means, suchas, the samememory, etc., tobesharedwith, commonly.

Next, the determining portion 243 for determining on suitableness/unsuitableness in alignment reads out the characteristic quantities of the middle-class foreign matters, based on the electron image of foreign matters from the defect characteristic quantity memorizing portion 242, wherein determination is made on the suitableness/unsuitableness in alignment (S91), by comparing the value of the brightness (i.e., the contrast (the averaged shade value) “C”) or the outline configuration value “f”, or the values of both the contrast “C” and the outline configuration value “f”, to a criterion of a reference value (i.e., a reference value of contrast or/and 4π indicative of the spherical configuration), so that the middle-class foreign matter showing a contract higher than the reference value thereof, or that showing the spherical configuration is determined to be suitable in alignment.

In case of being determined to be unsuitable in the said determination, the process turns back to the step S87 for selecting the next alignment candidates of middle-class foreign matters, and then the steps S87 to S91 are repeated, again.

In the determination of suitableness/unsuitableness in alignment, the contrast “C” and the outline configuration value “f” are used to be the attributes of the middle-class foreign matters, in order to determine the spherical foreign matters, which show a preferable contract and have a middle-class size, however, although the configuration value “f” as the attribute is effective in determination of the spherical foreign matters, but in the place, thereof it may be substituted by the area “S” of the middle-class foreign matter.

As was explained in the above, determination is made on the suitableness/unsuitableness in alignment, by using the contrast “C” and the outline configuration value “f”, to be the attributes of the middle-class foreign matter obtainable from the electron image of foreign matters, which can be obtained through picking up the image thereof from the electron microscope 30; thereby, enabling the determination, most suitably.

(11) Next, the coordinate calculating portion 244 reads out the electron image of foreign matters of the middle-class foreign matters, which are determined to be suitable in alignment, from the defect characteristic quantity memorizing portion 242, so as to calculate coordinates (X+ΔX,Y+ΔY) of position of gravity of the middle-class foreign matters within the coordinate system on the sample (S92), and as is shown in the right-hand side column in FIG. 12, the secondary registration is made on the position coordinates (X+ΔX,Y+ΔY) of the middle-class foreign matters, which are suitable in alignment, i.e., the coordinate values thereof are recorded into the defect characteristic quantity memorizing portion 242. The results of the suitableness/unsuitableness are also memorized into the defect characteristic quantity memorizing portion 242.

Next, in the determination on the number of times for alignment within the step S91 in the suitableness/unsuitableness determining portion 243, the steps S87 to S92 will be repeated until when the number of the middle-class foreign matters suitable in alignment be equal or greater than a threshold value, and calculation of the position coordinates is made on a predetermined number of the middle-class foreign matters within the coordinate calculating portion 244, in the similar manner. As aresult thereof, it is possible to calculate out the predetermined number of the position coordinates of the middle-class foreign matters, which are most suitably selected for use in alignment, with high accuracy.

However, at this stage, as is shown in FIG. 10, it is possible to display distribution of the middle-class foreign matters on the sample (i.e., the wafer), which are determined to be suitable for alignment, and the block areas or regions divided, on the screen of the display portion 23, and further on it, it is also possible to display the information obtainable from the inspecting apparatus in relation to the designated middle-class foreign matter, the characteristic quantities obtainable through the SEM observation, and the SEM position coordinates calculated by the SEM observation, through designation of an arbitrary middle-class foreign matter with using an input means 105, such as, an operation mouse, etc., and thereby to confirm on the suitableness/unsuitableness for alignment. Also, as will be mentioned later, displaying the compensated position coordinates, which are calculated by using the relative position compensation coefficients obtained, in parallel with the SEM position coordinates mentioned above, enables to confirm on whether N pieces of the middle-class foreign matters are appropriate or not, which are determined to be suitable for alignment.

(12) Thereafter, within the relative position compensating portion 245, the alignment compensation coefficients or factors (α₁₁, α₁₁, α₁₂, α₂₁, α₂₂, X₀, Y₀) are calculated out (S94), so that the error comes down to the minimum from the relationship expressed by an equation (1), which will be shown below, between the position coordinates (X+ΔX,Y+ΔY) of thepredetermined number of (e.g., “N” pieces) of the middle-class foreign matters, which are memorized in the defect characteristic quantity memorizing portion 242 and the position coordinates (X,Y) of the predetermined number of (e.g., “N” pieces) of the middle-class foreign matters within the inspecting apparatus 1, which are memorized in the defect primary selecting and memorizing portion 241, with using an approximation method of least squares, etc. And, the alignment compensation coefficients or factors (α₁₁, α₁₂, α₂₁, α₂₂, X₀, Y₀) can be also calculated by the method, which is disclosed in Japanese Patent Laying-Open No. 2002-39959 (2002).
(X+ΔX)=α₁₁X+α₁₂Y+X₀(Y+ΔY)=α₂₁X+α₂₂Y+Y₀ (1)

As was explained in the above, since the alignment compensation coefficients or factors (α₁₁, α₁₂,α₂₁, α₂₂, X₀, Y₀) are calculated out by using “N” pieces of the middle-class foreign matters, which are suitable for alignment, within the relative position compensating portion 245, and are memorized into a memory portion (not shown in the figures); thereafter, the reviewing apparatus 2 calculates out the position coordinates (X+ΔX,Y+ΔY) of the detect within the sample coordinate system in the reviewing apparatus 2, so as to obtain compensation of coordinate position(ΔX,ΔY) as offsets, through conducting the coordinate conversion from the position coordinates (X,Y) of the defect within the sample coordinate system, which is detected in the inspecting apparatus 1, about the defects to be reviewed, with using the alignment compensation coefficients mentioned above upon basis of the equation (1) mentioned above, in the general computer 24; and therefore, it is able to position the review defect within the view field of the electron microscope 30 of high magnification power, having the resolution, such as, about 512×512 pixels, so as to execute the detailed inspection of observing the details thereof through the SEM image of high magnification power, i.e., enabling to perform the defect review (ADR) (S814). Further, it executes the defect classification (ADC) upon basis of the said defect review (S815), thereby enabling a series of the detailed inspections.

By the way, it is also possible to conduct the compensation of coordinate positions and the detailed inspections mention above, in a manner of semi-automatic or full automatic.

However, in case where an image cannot be taken with wide view field and at high density, such as, about 2,048×2,048, in the step S88, it may be taken, again, several times, while moving the image pickup position around the periphery thereof (front and back or left to right); i.e., detection may be made while moving the view field (being called by “search land”). In such a case, as is shown in FIG. 14, into the flowchart shown in FIG. 8 are added a step (S911) for determining on necessity/unnecessary of re-taking or capturing the electron image in relation with the middle-class foreignmatters, which are determined to be unsuitable within the determination on suitableness/unsuitableness for alignment (S91), and also a step (S912) for changing the view filed in case when the re-capturing is necessary. Within the step (S911) for determining on necessity/unnecessary of re-capturing the electron image, the general computer 24 determines the necessity/unnecessary of re-capturing from a relationship between the view field of the electron image, which is taken into with wide view field and at high density, and the position coordinates of the alignment candidate of foreign matters. In case when the re-capturing is necessary, the general computer 24 transmits control signals (15) to the stage controller of the electron microscope 30, so as to change the view field (S912), and the processes will be repeated from the (8) re-capturing the SEM image (S88), again. Also, the general computer 24 conducts the selection of next alignment candidate (S87), when the re-capturing is not necessary.

<Embodiment 2>

Next, explanation will be given about a second embodiment, wherein, in the reviewing apparatus 2, the relative compensation coefficients (α₁₁, α₁₂, α₂₁, α₂₂, X₀, Y₀) are calculated out, with using the defect inspection information 4 stored within the defect selecting and memorizing portion 241, for executing the alignment within the reviewing apparatus 2, so as to compensate the position coordinates of defects detected in the inspecting apparatus 1 upon basis of the relative compensation coefficients, and thereby conducts the defect review (ADR) and the defect classification (ADC) with using the said position coordinates compensated, in the reviewing apparatus 2, by referring to a flowchart shown in FIG. 9.

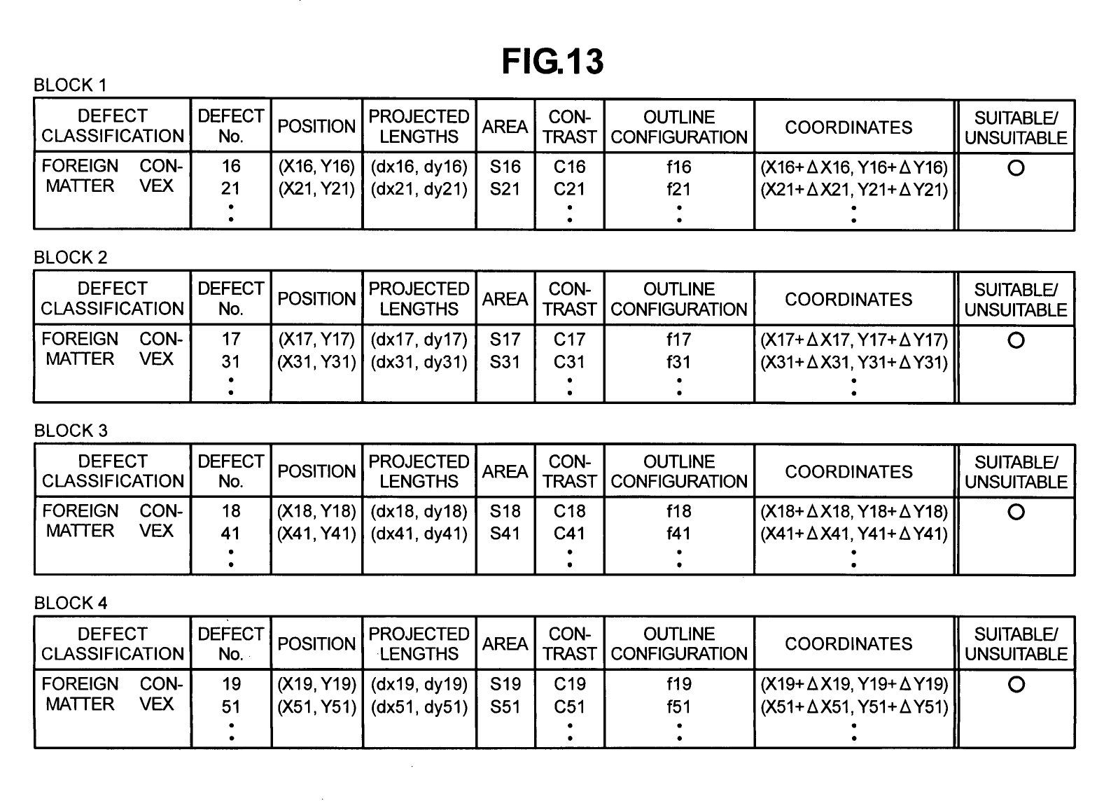

An aspect differing from the first embodiment in the second embodiment is to apply the optical microscope 42, which is provided within the reviewing apparatus, as shown in FIG. 3. As a first way of using the optical microscope 42, while moving the stages 31 and 32 of the reviewing apparatus 2 (S97), the middle-class foreign matters can be positioned within the view field of the optical microscope, easily, through selecting the alignment candidates of those middle-class foreign matters (S87), so as to obtain an optical image of the middle-class foreign matters (S98). Then, upon basis of the said optical image obtained, the position coordinates (X′,Y′) andthe sizes ((projected lengths dx,dy) or/and the area S) are obtained, again, of the middle-class foreign matters, to be registered into the defect characteristic quantity memorizing portion 242 (S99). Upon the said the sizes of the middle-class foreign matters registered, determination is made upon suitableness/unsuitableness for use in alignment (S100), and in case when determining the unsuitableness, then the process turns back to the step S97, on the other hand in case when determining the suitableness, the stages 31 and 32 are moved to as side of the direction of the electron microscope (S101). Thereby, it is possible to achieve the determination on the suitableness/unsuitableness for alignment, with certainty, and further to use the position coordinates (X′,Y′) mentioned above in the positioning within the view field of the electron microscope 30. FIG. 13 shows the data, which are registered, secondarily, into the defect characteristic quantity memorizing portion 242, in the case of this second embodiment.

A second way of using the optical microscope 42 is in a case where it is impossible to obtain the information about the sizes of foreign matters, but only the position coordinates and the number of defects, as the defect inspection information obtained from the inspecting apparatus in the upstream. In such case, the optical microscope 42 is used for obtaining the information of the sizes of foreign matters. For this reason, the step 100 is not provided therein, but steps S84 to S86 are inserted between the step S99 and the step 101, and the step S97 is provided only for the selection of foreign matters.

Further, in the second embodiment mentioned above can be applied the optical microscope 42, which is provided within the reviewing apparatus 2, even if the structure thereof is the dark-field lightening or illumination type as shown in FIG. 4, or if it is the bright-field illumination type as shown in FIG. 5, or it is of the type having both functions thereof, in common. However, in the case of the illumination type pf both functions, and if the detecting system is provided by one (1), the illumination must be switched over.

Of course, if not applying the optical microscope 42 therein, the structures and the operations thereof are also same to those of the first embodiment.

<Embodiment 3>

In case of the reviewing apparatus 2, the detecting system 21 of which, shown in FIG. 3, is constructed only with the optical microscope, the step S88 of the image picking-up mode by means of the electron microscope (SEM) in the flowchart shown in FIG. 8 must be replaced by an image picking-up mode by means of the optical microscope, to be applied therein, in the similar manner. In case of the optical microscope, it is possible to detect the defects under films, however since they are indefinite in the shape thereof, preferably they should be deleted from the candidates, as the defects for use in alignment.

The process of the defect-selecting portion 240, the process of the suitableness/unsuitableness determining portion 243, the process of the coordinate calculating portion 244, and the relative position compensating portion 245, mentioned above, are executed by the software system of the general computer system 24, in those embodiments, however those may be carried out by a software system of a processing computer to be used within the image processing system 22, in the place thereof.

Further, although the inspection is targeted upon the processed wafer, on the surface of which patters are formed, in the embodiment mentioned above, but the similar method may be applicable, for example, in case when conducting the detailed observation, to be achieved after inspection on a bare wafer before being formed with the patters thereon.

Also, with the present embodiment explained above, it is possible to obtain the alignment compensation coefficients (i.e., the relative position compensation coefficients), at high accuracy, for alignment within the sample coordinate system between the inspecting apparatus and the reviewing apparatus, by making the primary selection upon the alignment candidates, upon basis of the information (e.g., the projected lengths, the area, etc.) of the said spherical foreign matters from the plural numbers of defects (i.e., foreign matters), which are obtained from the inspecting apparatus, and making the secondary selection, upon the alignment candidates, which are selected in the primary selection, further upon basis of the information (e.g., the contrast, and the outline configuration, etc.) of the spherical defects (i.e., foreign matters), which are obtained through the image picking-up within the reviewing apparatus; thereby, finally achieving the picking-up or screening of the middle-class foreign matters, narrowly into the predetermined number thereof, which are suitable for use of alignment on the sample, with high reliability. As a result thereof, it is possible to improve the reliability in the alignment (i.e., the positioning) within the reviewing apparatus, in particular, for the defects at desire, which are detected in the inspecting apparatus, and thereby to conduct the defect review (ADR) and the defect classification (ADC) upon basis of the detailed observation, with high efficiency and at high accuracy.

Also, with the present embodiment, since the primary selection of the alignment candidates is made for each of the areas or regions divided on the sample, therefore the alignment candidates can be picked up or screened narrowly, in a manner relatively equal, all over the entire areas or regions on the sample, even for the spherical defects of being further minute or detailed. As a result of this, it is possible to obtain the relative position compensation coefficients for alignment, at high accuracy, all over the entire regions of the sample. And, as a result, it is possible to improve the reliability on the alignment (i.e., the positioning) within the reviewing apparatus, and thereby enabling the detailed observation of the defects at desire, with high accuracy, in the reviewing apparatus.

Also, according the present embodiment, visual determination by eyes or operation by an operator is hardly required; therefore, the alignment can be achieved within a short time period, at high efficiency, and further automatic operation can be achieved within the defect reviewing appareatus.

The invention may be embodied in other specific forms without departing from the spirit or essential characteristics thereof. The present embodiments are therefore to be considered in all respects as illustrative and not restrictive, the scope of the invention being indicated by the appended claims rather than by the forgoing description and all changes which come within the meaning and range of equivalency of the claims are therefore to be embraces therein.

What is claimed is:

1. A reviewing apparatus, for observing defects detected in an inspecting apparatus provided in an upstream, comprising:
a memorizing portion for memorizing defect inspection information about a large number of defects lying on a surface of an target tobe inspected, which are detected within said upstream inspecting apparatus;
a defect selecting portion for selecting and picking up a plural number of alignment candidates, narrowly, from said large number of defects, upon basis of sorts and/or attribute information included within the defect inspection information memorized in. said memorizing portion;
a detecting system for obtaining SEM images or optic images of the plural number of alignment candidates, which are selected narrowly within said defect selecting portion, by picking up an image thereof, respectively;
an image processing portion for calculating out characteristic quantities indicative of attributes about the plural number of alignment candidates, from the SEM images or the optic images of the plural number of alignment candidates, which are obtained in said detecting system;
a determining portion for determining on suitableness/unsuitableness for use in alignment, about said plural number of alignment candidates, upon basis of the characteristic quantities indicative of attributes about the plural number of alignment candidates, which are calculated in said image processing portion; and
a relative position compensating portion for calculating out alignment compensation coefficients from position coordinates obtainable from said inspecting apparatus, which are included within said defect inspection information, about the plural number of alignment candidates, which are determine to be suitable for use in alignment within said determining portion, and position coordinates within said reviewing apparatus, which are calculated from the SEM image or the optic image of said alignment candidates.

2. The reviewing apparatus, as is described in the claim 1, wherein said defect selecting portion picks up, narrowly, spherical defects of middle-class sizes, upon the sorts and/or the attribute information of said defects.

3. The reviewing apparatus, as is described in the claim 1, wherein said defect selecting portion selects a predetermined number of the alignment candidates from each of blocks, which are divided into plural numbers thereof on the surface of said target to be inspected.

4. The reviewing apparatus, as is described in the claim 1, wherein the attribute information of said defects within said defect selecting portion is indicative of sizes of the defects.

5. The reviewing apparatus, as is described in the claim 1, wherein the characteristic quantities calculated out to be the attributes about the alignment candidates within said image processing portion are contrasts and/or outline configurations, and within said determining portion, the suitableness/unsuitableness for alignment are determined on the alignment candidates upon basis of said contrasts and/or outline configurations.

6. The reviewing apparatus, as is described in the claim 1, wherein the suitableness/unsuitableness for alignment are determined by comparing the characteristic quantities indicative of the attributes of said alignment candidates with a reference value, within said determining portion.

7. The reviewing apparatus, as is described in the claim 1, further comprising an optical microscope for obtaining an optic image of the defects or the alignment candidates.

8. A reviewing apparatus, for observing defects detected in an inspecting apparatus provided in an upstream, comprising:
a memorizing portion for memorizing defect inspection information about a large number of defects lying on a surface of an target to be inspected, which are detected within said upstream inspecting apparatus;
a defect selecting portion for selecting and picking up a plural number of alignment candidates, narrowly, from said large number of defects, upon basis of sorts and/or attribute information included within the defect inspection information memorized in said memorizing portion;
an electron microscope for obtaining SEM images of the plural number of alignment candidates, which are selected narrowly within said defect selecting portion, by picking up an image thereof, respectively;
an image processing portion for calculating out characteristic quantities indicative of attributes about the plural number of alignment candidates, from the SEM images of the plural number of alignment candidates, which are obtained in said electron microscope;
a determining portion for determining on suitableness/unsuitableness for use in alignment, about said plural number of alignment candidates, upon basis of the characteristic quantities indicative of attributes about the plural number of alignment candidates, which are calculated in said image processing portion; and
a relative position compensating portion for calculating out alignment compensation coefficients from position coordinates obtainable from said inspecting apparatus, which are included within said defect inspection information, about the plural number of alignment candidates, which are determine to be suitable for use in alignment within said determining portion, and position coordinates within said reviewing apparatus, which are calculated from the SEM image of said alignment candidates.

9. The reviewing apparatus, as is described in the claim 8, wherein said defect selecting portion picks up, narrowly, spherical defects of middle-class sizes, upon the sorts and/or the attribute information of said defects.

10. The reviewing apparatus, as is described in the claim 8, wherein said defect selecting selects a predetermined number of the alignment candidates from each of blocks, which are divided into plural numbers thereof on the surface of said target to be inspected.

11. The reviewing apparatus, as is described in the claim 8, wherein the attribute information of said defects within said defect selecting portion is indicative of sizes of the defects.

12. The reviewing apparatus, as is described in the claim 8, wherein the characteristic quantities calculated out to be the attributes about the alignment candidates within said image processing portion are contrasts and/or outline configurations, and within said determining portion, the suitableness/unsuitableness for alignment are determined on the alignment candidates upon basis of said contrasts and/or outline configurations.

13. The reviewing apparatus, as is described in the claim 8, wherein the suitableness/unsuitableness for alignment are determined by comparing the characteristic quantities indicative of the attributes of said alignment candidates with a reference value, within said determining portion.

14. The reviewing apparatus, as is described in the claim 8, further comprising an optical microscope for obtaining an optic image of the defects or the alignment candidates.

15. A reviewing method, for observing defects detected in an inspecting apparatus provided in an upstream, comprising the following steps of:
a memorizing step for memorizing defect inspection information about a large number of defects lying on a surface of an target to be inspected, which are detected in inspection by said inspecting apparatus;
a defect selecting step for selecting and picking up a plural number of alignment candidates, narrowly, from said large number of defects, upon basis of sorts and/or attribute information included within the defect inspection information memorized in said memorizing step;
an image obtaining step for obtaining SEM images or optic images of the plural number of alignment candidates, which are selected narrowly within said defect selecting step, by picking up an image thereof, respectively, by means of a detecting system;
an image processing step for calculating out characteristic quantities indicative of attributes about the plural number of alignment candidates, from the SEM images or the optic images of the plural number of alignment candidates, which are obtained in said image obtaining step;
a determining step for determining on suitableness/unsuitableness for use in alignment, about said plural number of alignment candidates, upon basis of the characteristic quantities indicative of attributes about the plural number of alignment candidates, which are calculated in said image processing step; and
a compensation coefficient calculating step for calculating out alignment compensation coefficients from position coordinates obtainable from said inspecting apparatus, which are included within said defect inspection information, about the plural number of alignment candidates, which are determine to be suitable for use in alignment within said determining step, and position coordinates within said reviewing apparatus, which are calculated from the SEM image or the optic image of said alignment candidates.

16. The reviewing method, as is described in the claim 15, wherein spherical defects of middle-class sizes are picked up, narrowly, upon the sorts and/or the attribute information of said defects, within said defect selecting step.

17. The reviewing method, as is described in the claim 15, wherein a predetermined number of the alignment candidates are selected from each of blocks, which are divided into plural numbers thereof on the surface of said target to be inspected, within said defect selecting step.

18. The reviewing method, as is described in the claim 15, wherein contrasts and/or outline configurations are calculated out to be the attributes about the alignment candidates, within said image processing step, and the suitableness/unsuitableness for alignment are determined on the alignment candidates upon basis of said contrasts and/or outline configurations, within said determining step.

19. A reviewing method, for observing defects detected in an inspecting apparatus provided in an upstream, comprising the following steps of:
a memorizing step for memorizing defect inspection information about a large number of defects lying on a surface of an target to be inspected, which are detected in inspection by said inspecting apparatus;
a defect selecting step for selecting and picking up a plural number of alignment candidates, narrowly, from said large number of defects, upon basis of sorts and/or attribute information included within the defect inspection information memorized in said memorizing step;
a SEM image obtaining step for obtaining SEM images of the plural number of alignment candidates, which are selected narrowly within said defect selecting step, by picking up an image thereof, respectively, by means of an electron microscope;
an image processing step for calculating out characteristic quantities indicative of attributes about the plural number of alignment candidates, from the SEM images of the plural number of alignment candidates, which are obtained in said SEM image obtaining step;
a determining step for determining on suitableness/unsuitableness for use in alignment, about said plural number of alignment candidates, upon basis of the characteristic quantities indicative of attributes about the plural number of alignment candidates, which are calculated in said image processing step; and
a compensation coefficient calculating step for calculating out alignment compensation coefficients from position coordinates obtainable from said inspecting apparatus, which are included within said defect inspection information, about the plural number of alignment candidates, which are determine to be suitable for use in alignment within said determining step, and position coordinates within said reviewing apparatus, which are calculated from the SEM image of said alignment candidates.

20. The reviewing method, as is described in the claim 19, wherein spherical defects of middle-class sizes are picked up, narrowly, upon the sorts and/or the attribute information of said defects, within said defect selecting step.

21. The reviewing method, as is described in the claim 19, wherein a predetermined number of the alignment candidates are selected from each of blocks, which are divided into plural numbers thereof on the surface of said target to be inspected, within said defect selecting step.

22. The reviewing method, as is described in the claim 19, wherein contrasts and/or outline configurations are calculated out to be the attributes about the alignment candidates, within said image processing step, and the suitableness/unsuitableness for alignment are determined on the alignment candidates upon basis of said contrasts and/or outline configurations, within said determining step.

23. The reviewing method, as is described in the claim 19, wherein an image picking up is made on the alignment candidates with a field view, which is wider than that when conducting defect observation (ADR), and at a image sampling number, which is larger than that when conducting the defect observation (ADR).
